(19) United States
(12) Patent Application Publication
(10) Pub. No.: US 2017/0039851 A1
(43) Pub. Date: Feb. 9, 2017

(54) METHOD AND DEVICE FOR GUIDING A VEHICLE

(71) Applicant: Robert Bosch GmbH, Stuttgart (DE)

(72) Inventor: Stefan Nordbruch, Kornwestheim (DE)

(21) Appl. No.: 15/227,640

(22) Filed: Aug. 3, 2016

(30) Foreign Application Priority Data
Aug. 4, 2015 (DE) 102015214802.5

(51) Int. Cl. G08G 1/0968; G01C 21/36; G01C 21/20; G08G 1/14; G01C 21/34

(52) U.S. Cl. CPC G08G 1/096855; G08G 1/096872; G08G 1/146; G08G 1/143; G08G 1/144; G01C 21/3415; G01C 21/206; G01C 21/365; G01C 21/3629

(57) ABSTRACT

A method for guiding a vehicle from a starting position in a parking facility to a target position in the parking facility. The method includes ascertaining a route from the starting position to the target position, ascertaining driving data based on the ascertained route in such a way that a driver of the vehicle may manually drive the vehicle from the starting position to the target position, based on the driving data, and transmitting the ascertained driving data via a communication network to a terminal included in the vehicle. A corresponding device, a parking facility, a vehicle, and a computer program are also described.

### CROSS REFERENCE

The present application claims the benefit under 35 U.S.C. §119 of German Patent Application No. DE 102015214802.5 filed on Aug. 4, 2015, which is expressly incorporated herein by reference in its entirety.

### FIELD

The present invention relates to a method and a device for guiding a vehicle from a starting position in a parking facility to a target position in the parking facility.

Moreover, the present invention relates to a parking facility, a vehicle, and a computer program.

### BACKGROUND INFORMATION

German Patent Application DE 10 2012 222 562 A1 describes a system for managed parking lots for transferring a vehicle from a starting position to a target position.

In fully automated (autonomous) so-called valet parking, a vehicle is parked by its driver at a drop-off point, for example in front of a parking garage, and from there the vehicle drives itself into a parking position/parking bay and back to the drop-off point.

In order for a vehicle to be able to carry out the fully automated valet parking, it must generally meet certain requirements. For example, the vehicle must include sensors, for example ultrasonic sensors, vehicle start/stop mechanisms, and controllable actuators, for example brakes, steering, and a motor.

These requirements or conditions are generally not met by all vehicles.

### SUMMARY

An object of the present invention is to provide an efficient method and device for efficiently guiding a vehicle from a starting position in a parking facility to a target position in the parking facility, without the vehicle absolutely having to meet the above-mentioned requirements or conditions.

According to one aspect of the present invention, a method for guiding a vehicle from a starting position in a parking facility to a target position in the parking facility is provided, which includes the following steps:
ascertaining a route from the starting position to the target position,
ascertaining driving data based on the ascertained route in such a way that a driver of the vehicle may manually drive the vehicle from the starting position to the target position, based on the driving data, and
transmitting the ascertained driving data via a communication network to a terminal included in the vehicle.

According to another aspect of the present invention, a device for guiding a vehicle from a starting position in a parking facility to a target position in the parking facility is provided, which includes:
an ascertainment device for ascertaining a route from the starting position to the target position,
the ascertainment device being designed for ascertaining driving data, based on the ascertained route, in such a way that a driver of the vehicle may manually drive the vehicle from the starting position to the target position, based on the driving data, and
a communication interface for transmitting the ascertained driving data via a communication network to a terminal included in the vehicle.

According to another aspect of the present invention, a parking facility for vehicles is provided which includes the device for guiding a vehicle from a starting position to a target position in the parking facility.

According to another aspect of the present invention, a vehicle is provided which includes:
a terminal for receiving driving data via a communication network, on the basis of which a driver of the vehicle may manually drive the vehicle from a starting position in a parking facility to a target position in the parking facility, and
a human-machine interface for providing the received driving data in human-processable form.

According to another aspect of the present invention, a computer program is provided which includes program code for carrying out the method for guiding a vehicle from a starting position in a parking facility to a target position in the parking facility when the computer program is executed on a computer.

In accordance with the present invention, among other things, the vehicle is still driven manually by the driver within the parking facility from the starting position to the target position. However, it is provided according to the present invention that the driver of the vehicle is instructed on how he/she may arrive at the target position from the starting position. This is achieved in that driving data are ascertained, and these driving data are transmitted via the communication network to the terminal included in the vehicle. It is thus advantageously made possible for the driving data to be provided to the driver with the aid of the terminal. This results in particular in the technical advantage that the driver may efficiently drive the vehicle manually from the starting position to the target position, based on the driving data received with the aid of the terminal.

Thus, the driver him/herself no longer has to know the exact location of the target position within the parking facility, or which route he/she must take to the target position. This is ascertained externally, i.e., outside the vehicle, this information then being provided to the driver via the communication network. This results in particular in the technical advantage that the vehicle may be efficiently guided from the starting position to the target position without the vehicle having to meet requirements as mentioned in the introduction to the description. For example, the vehicle therefore does not have to include controllable actuators, vehicle start/stop mechanisms, or sensors, for example ultrasonic sensors, radar sensors, or video sensors. This means that the vehicle itself does not have to be designed for an automatic parking operation.

However, services within the scope of the automatic parking operation, for example reserving a parking position or finding the parking position within the parking facility, may still be offered and carried out. Instead of the vehicle being driven automatically to the parking position, the driver him/herself now drives. This means that the design of the vehicle does not have to be as technically complex as a vehicle that is designed for carrying out an automatic parking operation. The vehicle is thus manually driven, and the driver is instructed and/or guided.

According to one specific embodiment, the terminal is a mobile terminal, for example a mobile telephone. This may be, for example, the mobile terminal of the driver or of a vehicle occupant.

According to one specific embodiment, the terminal is a terminal that is integrated into the vehicle.

According to another specific embodiment, it is provided that manual driving of the vehicle from the starting position to the target position is monitored and checked for errors, and in the event of an error, correction data for correcting the error are ascertained, and the correction data are transmitted to the terminal via the communication network.

This results in particular in the technical advantage that errors occurring in conjunction with the manual driving may be efficiently corrected. For example, it is monitored whether the driver is correctly driving on the setpoint trajectory communicated to him/her. In the event of a deviation from this setpoint trajectory, for example a correction trajectory is ascertained and transmitted to the terminal via the communication network, so that the driver may correct his/her driving, based on the correction trajectory, in order to return to the original setpoint trajectory.

For example, within the scope of the monitoring it has been determined that the driver has missed a turn or has driven past the parking position provided for him/her. It is then ascertained, for example, which route or which trajectory the driver must travel in order to return to the parking position. This route or trajectory is then communicated to the driver via the communication network.

According to another specific embodiment, it is provided that when an operational disruption, in particular a holdup, occurs within the parking facility during manual driving of the vehicle from the starting position to the target position, it is checked whether the operational disruption requires an adaptation of the route and/or of the target position, and if adaptation is necessary, adapted driving data corresponding to the operational disruption are ascertained and transmitted to the terminal via the communication network.

This results in particular in the technical advantage that an operational disruption does not necessarily result in the vehicle no longer being guidable to its target position. This results in particular in the technical advantage that a response to the operational disruption, for example a holdup within the parking facility, may be efficiently made. This is achieved in particular in that adapted driving data are ascertained as needed, on the basis of which, for example, an obstacle may be bypassed. An operational disruption includes, for example, a holdup and/or, for example, that another vehicle within the parking facility has had an accident or for some other reason is blocking a driving path within the parking facility. A holdup, for example, may likewise block the driving path. If the other vehicle is situated on the ascertained route, the other vehicle would block the guided vehicle. This means that the guided vehicle could not easily drive to its target position. However, due to adapted driving data being ascertained, the guided vehicle may advantageously be guided around the obstacle, in the present case the other vehicle and/or the holdup, and thus guided to its target position.

In another specific embodiment, it is provided that another route from another position situated outside the parking facility to the starting position is ascertained, additional driving data based on the ascertained other route being ascertained in such a way that the driver of the vehicle may manually drive the vehicle from the other position to the starting position, based on the additional driving data, the additional driving data being transmitted to the terminal via the communication network.

This results in particular in the technical advantage that the vehicle may be efficiently guided from another position, situated outside the parking facility, to the starting position. According to one specific embodiment, the other position outside the parking facility corresponds to an instantaneous position of the vehicle. This means that the vehicle may be efficiently guided from its instantaneous position to the starting position.

In one specific embodiment, it is provided that another route from the target position to another position situated outside the parking facility is ascertained, other driving data based on the ascertained other route being ascertained in such a way that the driver of the vehicle may manually drive the vehicle from the target position to the other position, based on the other driving data, the other driving data being transmitted to the terminal via the communication network.

This results in particular in the technical advantage that the vehicle may be efficiently guided from the target position to the other position. According to one specific embodiment, the other position is another target position of the vehicle to which the vehicle is to be driven after the end of a parking operation.

The statements made in conjunction with the manual driving of the vehicle from the starting position to the target position, and the described specific embodiments, similarly apply to the manual driving of the vehicle from the other position to the starting position and/or from the target position to the other position.

This means that, for example, monitoring of this manual driving is analogously provided.

According to one specific embodiment, the communication network includes a WLAN network and/or a mobile communications network and/or a communication network according to the LoRa standard. “LoRa” stands for “low-power wide-area communication.” According to one specific embodiment, the communication network thus includes a LoRa communication network.

According to one specific embodiment, a communication via the communication network is or becomes encrypted.

According to one specific embodiment, the vehicle is a motor vehicle, for example, in particular a passenger vehicle or a truck. The vehicle is a two-wheeled motor vehicle, for example, such as a motorcycle. Thus, within the meaning of the present invention, vehicles are motor vehicles, for example.

Within the meaning of the present invention, a parking facility is used as a parking area for vehicles. The parking facility thus forms in particular a contiguous area which includes multiple parking spaces for a parking facility on private property, or multiple parking positions for a parking facility on public property. The parking spaces on private property or parking positions on public property are thus parking areas, which for the sake of simplicity may also be referred to as parking positions. According to one specific embodiment, the parking facility is designed as a parking deck. According to another specific embodiment, the parking facility is designed as a parking garage.

According to one specific embodiment, it is provided that driving data include one or multiple elements selected from the following group of driving data: map data of a digital map of the parking facility and/or of the surroundings of the parking facility, setpoint trajectory data of a setpoint trajectory to be embarked on by the vehicle, and driving instruction data of driving instructions to be followed by the driver of the vehicle.

This results in particular in the technical advantage that the vehicle may be efficiently guided. The driver thus obtains a digital map of the parking facility and/or of the surroundings of the parking facility, based on the map data, so that the driver may efficiently navigate on the basis of this digital map. Providing the setpoint trajectory data results in particular in the technical advantage that the driver is informed of the setpoint trajectory to be embarked on. The driver may thus efficiently embark on the route. The technical advantage of driving instruction data is to be seen in particular in that the driver may be efficiently directed on how to drive, for example in order to arrive at the starting position and/or the target position and/or the other position. Driving instructions include the following instructions, for example: “drive to the left” and “drive to the right.”

When driving data are described in general, this includes in particular the adapted driving data and/or the additional driving data and/or the other driving data.

The human-machine interface is designed for processing the driving data, and instructing the driver corresponding to the processed driving data. For example, the human-machine interface is designed for displaying the digital map and/or the setpoint trajectory and/or for acoustically outputting the driving instructions.

According to one specific embodiment, it is provided that the device for guiding a vehicle from a starting position in a parking facility to a target position in the parking facility is designed or configured for executing or carrying out the method for guiding a vehicle from a starting position in a parking facility to a target position in the parking facility.

Technical functionalities of the device similarly result from corresponding technical functionalities of the method, and vice versa.

This means in particular that the ascertainment device in particular is designed for checking monitored manual driving of the vehicle for errors, the ascertainment device also being designed, in the event of an error, for ascertaining correction data for correcting the error, and the communication interface being designed for transmitting the correction data to the terminal via the communication network. This similarly applies to other specific embodiments with regard to the adapted driving data and/or the additional driving data and/or the other driving data. This means that the ascertainment device is accordingly designed for ascertaining the adapted driving data and/or the additional driving data and/or the other driving data. The communication interface is designed in particular for transmitting these driving data mentioned above to the terminal via the communication network.

According to one specific embodiment, a monitoring system is provided which is designed for monitoring manual driving of the vehicle from the starting position to the target position. The monitoring system is, for example, incorporated by the parking facility. According to one specific embodiment, the monitoring system includes one or multiple surroundings sensors. A surroundings sensor is one of the following surroundings sensors, for example: radar sensor, video sensor, laser sensor, ultrasonic sensor, LIDAR sensor, or magnetic sensor.

According to one specific embodiment, the human-machine interface is designed for providing the received driving data in haptic and/or acoustic and/or visual form. Thus, for example, the human-machine interface includes a screen for displaying the digital map and/or the setpoint trajectory to be embarked on and/or the driving instructions. For example, the human-machine interface includes a speaker for acoustically outputting driving instructions.

According to one specific embodiment, the human-machine interface is incorporated by the terminal, i.e., is integrated into the terminal, for example.

According to one specific embodiment, the terminal and the human-machine interface are physically separate and are connected to one another via a communication link.

This is, for example, a terminal of a driver of the vehicle. The human-machine interface is a human-machine interface that is integrated into the vehicle. The terminal then communicates with this human-machine interface, for example, via a wireless or wired communication network which is installed in the vehicle. This wireless communication network includes a Bluetooth network and/or a WLAN network, for example.

The present invention is explained in greater detail below with reference to preferred exemplary embodiments.

### BRIEF DESCRIPTION OF THE DRAWINGS

FIG. 1 shows a flow chart of a method for guiding a vehicle from a starting position in a parking facility to a target position in the parking facility.

FIG. 2 shows a device for guiding a vehicle from a starting position in a parking facility to a target position in the parking facility.

FIG. 3 shows a parking facility for vehicles.

FIG. 4 shows a vehicle.

### DETAILED DESCRIPTION OF EXAMPLE EMBODIMENTS

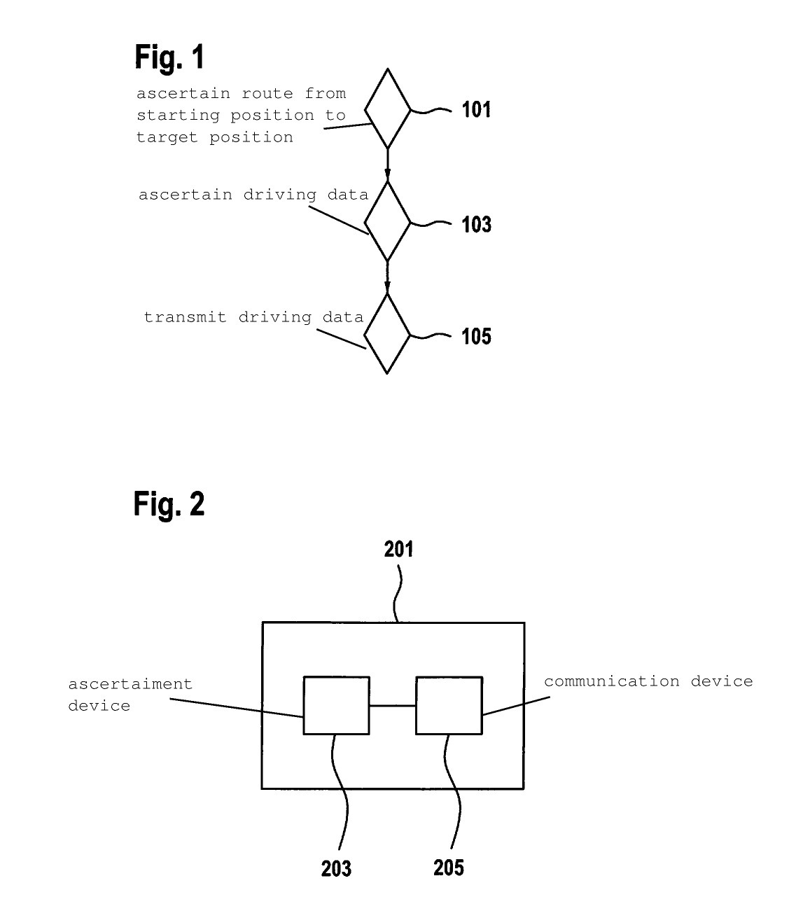

FIG. 1 shows a flow chart of a method for guiding a vehicle from a starting position in a parking facility to a target position in the parking facility.

The method includes the following steps:
ascertaining 101 a route from the starting position to the target position,
ascertaining 103 driving data based on the ascertained route in such a way that a driver of the vehicle may manually drive the vehicle from the starting position to the target position, based on the driving data, and
transmitting 105 the ascertained driving data via a communication network to a terminal included in the vehicle.

FIG. 2 shows a device 201 for guiding a vehicle from a starting position in a parking facility to a target position in the parking facility.

Device 201 includes:
an ascertainment device 203 for ascertaining a route from the starting position to the target position,
the ascertainment device being designed for ascertaining driving data, based on the ascertained route, in such a way that a driver of the vehicle may manually drive the vehicle from the starting position to the target position, based on the driving data, and
a communication interface 205 for transmitting the ascertained driving data via a communication network to a terminal included in the vehicle.

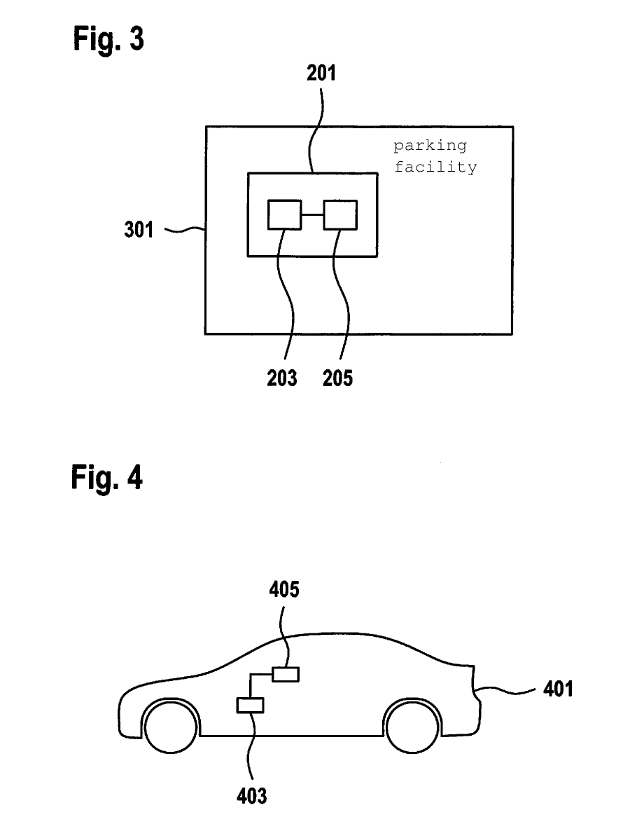

FIG. 3 shows a parking facility 301 for vehicles.

Parking facility 301 includes device 201 from FIG. 2. In one specific embodiment not shown, parking facility 301 includes a starting position and a target position. In another specific embodiment not shown, parking facility 301 includes one or multiple parking positions. In another specific embodiment not shown, parking facility 301 includes a monitoring system.

FIG. 4 shows a vehicle 401.

Vehicle 401 includes:
a terminal 403 for receiving driving data via a communication network, on the basis of which a driver of the vehicle may manually drive the vehicle from a starting position in a parking facility to a target position in the parking facility, and
a human-machine interface 405 for providing the received driving data in human-processable form.

The present invention thus includes in particular, and among other things, providing a technical solution which allows a vehicle to be efficiently guided and driven within a parking facility without the vehicle having to be designed for an automatic parking operation. Thus, the vehicle no longer has to include the vehicle components necessary for this purpose (sensors, vehicle start/stop mechanisms, controllable actuators).

In accordance with the present invention, due to the absence of vehicle components, the driver him/herself drives the vehicle, i.e., manually, but the driver is instructed on how to drive in order to arrive at the appropriate positions.

In particular, a drive or guidance to a reserved parking position, which may be designed as a parking bay, for example, and/or from the reserved parking position to an exit of the parking facility, is provided.

In one specific embodiment, the guidance of the vehicle begins upon entry into the parking facility. In another specific embodiment, the guidance of the vehicle begins at a drop-off position of the parking facility. The drop-off position refers to a position in the parking facility at which a vehicle is to be parked for an automatic parking operation. This means that a vehicle which is designed for an automatic parking operation is parked at such a drop-off position so that it may then carry out the automatic parking operation. The drop-off position may also be referred to as a drop zone. According to one specific embodiment, the drop-off position is the starting position. According to one specific embodiment, the target position is a parking position.

In another specific embodiment, the guidance ends upon exiting the parking facility. In another specific embodiment, the guidance ends at a pick-up position in the parking facility, which may also be referred to as a pick-up zone. A pick-up position refers to a position at which an automatic parking operation ends, i.e., at which a person may pick up the vehicle after an automatic parking operation has ended. According to one specific embodiment, the starting position is a parking position. In one specific embodiment, the target position is the pick-up position.

According to one specific embodiment, the path or the route is displayed and/or announced to the driver on his/her mobile terminal. In another specific embodiment, the path or the route is displayed and/or announced to the driver on a component onboard the vehicle. Such a component onboard the vehicle is encompassed by a human-machine interface, for example. For example, such a component onboard the vehicle is a main unit (also referred to as head unit) of an infotainment system, the head unit preferably including a communication interface or a communication unit.

In another specific embodiment, the manual driving is monitored; for example, the manual driving is monitored by a parking facility management system (in particular tracked online), and in the event of driving errors (for example, if the vehicle has driven past a parking bay) and/or when route changes are necessary (for example, due to the parking bay being temporarily occupied by another vehicle, or a lane in a level of the parking garage being blocked due to an accident), an update (adapted driving data) is communicated to the driver via the communication network. The parking facility includes such a parking facility management system, for example.

In another specific embodiment, the guidance (based on a digital map, for example) also begins outside the parking facility and/or may be continued outside the parking facility. In another specific embodiment, controlled guidance (including incorporation of the actual position of the vehicle) may also begin and/or be continued outside the parking facility. A controlled guidance includes in particular monitored guidance, appropriate correction data being transmitted to the terminal of the vehicle when errors are detected.

In another specific embodiment, when the vehicle is parked within the parking facility, the route to the parking position of the vehicle is displayed and/or announced to a future driver of the vehicle on his/her mobile terminal upon pickup of the vehicle. Thus, the route to the vehicle is displayed and/or announced to the future driver. In another specific embodiment, the future driver is tracked and guided in a controlled manner by the parking facility management system, for example. This means that the driver is informed, for example, when he/she becomes lost, and how to return to his/her original route.

What is claimed is:

1. A method for guiding a vehicle from a starting position in a parking facility to a target position in the parking facility, comprising:
ascertaining a route from the starting position to the target position;
ascertaining driving data based on the ascertained route in such a way that a driver of the vehicle may manually drive the vehicle from the starting position to the target position, based on the driving data; and
transmitting the ascertained driving data via a communication network to a terminal included in the vehicle.

2. The method as recited in claim 1, wherein manual driving of the vehicle from the starting position to the target position is monitored and checked for errors, and in the event of an error, correction data for correcting the error are ascertained, and the correction data are transmitted to the terminal via the communication network.

3. The method as recited in claim 1, further comprising:
when an operational disruption occurs within the parking facility during manual driving of the vehicle from the starting position to the target position, checking whether the operational disruption requires an adaptation of at least one of the route and the target position; and
if adaptation is necessary, ascertaining adapted driving data corresponding to the operational disruption, and transmitting the adapted driving data to the terminal via the communication network.

4. The method as recited in claim 1, further comprising:
ascertaining another route from another position situated outside the parking facility to the starting position, additional driving data based on the ascertained other route being ascertained in such a way that the driver of the vehicle may manually drive the vehicle from the other position to the starting position, based on the additional driving data; and
transmitting the additional driving data to the terminal via the communication network.

5. The method as recited in claim 1, further comprising:
ascertaining another route from the target position to another position situated outside the parking facility, other driving data based on the ascertained other route being ascertained in such a way that the driver of the vehicle may manually drive the vehicle from the target position to the other position, based on the other driving data; and
transmitting the other driving data to the terminal via the communication network.

6. The method as recited in claim 1, wherein driving data include one or multiple elements selected from the following group of driving data: map data of a digital map of the parking facility, map data of a digital map of surroundings of the parking facility, setpoint trajectory data of a setpoint trajectory to be embarked on by the vehicle, and driving instruction data of driving instructions to be followed by the driver of the vehicle.

7. A device for guiding a vehicle from a starting position in a parking facility to a target position in the parking facility, comprising:
an ascertainment device for ascertaining a route from the starting position to the target position, the ascertainment device being designed for ascertaining driving data, based on the ascertained route, in such a way that a driver of the vehicle may manually drive the vehicle from the starting position to the target position, based on the driving data; and
a communication interface for transmitting the ascertained driving data via a communication network to a terminal included in the vehicle.

8. A parking facility for vehicles, including a device for guiding a vehicle from a starting position in a parking facility to a target position in the parking facility, the device comprising:
an ascertainment device for ascertaining a route from the starting position to the target position, the ascertainment device being designed for ascertaining driving data, based on the ascertained route, in such a way that a driver of the vehicle may manually drive the vehicle from the starting position to the target position, based on the driving data; and
a communication interface for transmitting the ascertained driving data via a communication network to a terminal included in the vehicle.

9. A vehicle which includes:
a terminal for receiving driving data via a communication network, on the basis of which a driver of the vehicle may manually drive the vehicle from a starting position in a parking facility to a target position in the parking facility; and
a human-machine interface for providing the received driving data in human-processable form.

10. The vehicle as recited in claim 9, wherein the terminal is designed as a mobile terminal or is integrated into the vehicle.

11. A non-transitory computer-readable storage medium storing a computer program which includes program code for guiding a vehicle from a starting position in a parking facility to a target position in the parking facility, the program code, when executed by a computer, causing the computer to perform:
ascertaining a route from the starting position to the target position;
ascertaining driving data based on the ascertained route in such a way that a driver of the vehicle may manually drive the vehicle from the starting position to the target position, based on the driving data; and
transmitting the ascertained driving data via a communication network to a terminal included in the vehicle.
